(19) United States
(12) Patent Application Publication
(10) Pub. No.: US 2025/0230933 A1
(43) Pub. Date: Jul. 17, 2025

(54) GEOFENCING CONTROL MODES FOR A COOKING APPLIANCE

(71) Applicant: Haier US Appliance Solutions, Inc., Wilmington, DE (US)

(72) Inventor: Omar Santana, Louisville, KY (US)

(21) Appl. No.: 18/413,835

(22) Filed: Jan. 16, 2024

(51) Int. Cl. F24C 3/12; H04L 12/28

(52) U.S. Cl. CPC F24C 3/128; H04L 12/282

(57) ABSTRACT

A method of operating a cooking appliance may include enabling a geofencing mode defining a geofence condition. The method may also include determining a status of the geofence condition. The method may further include implementing a responsive action based on the determined status of the geofence condition.

### FIELD OF THE DISCLOSURE

The present subject matter relates generally to a cooking appliance, and more particularly, certain features or modes of operation of a cooking appliance.

### BACKGROUND OF THE DISCLOSURE

Conventional cooking appliances include a cooktop positioned on a top of the appliance that includes one or more heating elements, such as electric heaters, gas burners, or induction heating elements. Often, cooking appliances can also include a cabinet that includes a cooking chamber for receipt of food items for cooking. Multiple heating elements are positioned within the cooking chamber to provide heat to food items located therein. Cooking appliances that include both a cooking chamber and a cooktop are commonly referred to as “ranges.”

Often, cooking appliances include the ability to restrict access to certain features of the cooking appliance. For example, in certain modes of operation, access to a user interface panel of the cooking appliance may be limited or restricted. However, challenges currently exist with such modes of operation. For instance, a user may be required to manually interact with the cooking appliance to activate the modes of operations. Such manual interaction with the cooking appliance may become burdensome for the user to perform continuously (e.g., daily). Additionally or alternatively, such manual interaction may result in another user's experience with the cooking appliance being disrupted.

Accordingly, systems and methods that obviate one or more of the above drawbacks would be useful.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a method of operating a cooking appliance is provided. The method may include enabling a geofencing mode defining a geofence condition. The method may also include determining a status of the geofence condition. The method may further include implementing a responsive action based on the determined status of the geofence condition.

In another exemplary aspect of the present disclosure a cooking appliance is provided. The cooking appliance may define a vertical direction, a lateral direction, and a transverse direction. The cooking appliance may include a cooktop comprising one or more heating elements. The cooking appliance may also include a user interface panel mounted to the cooktop for facilitating user interaction with the cooking appliance. The cooking appliance may further include a controller in operative communication with the user interface panel. The controller may be configured for: enabling a geofencing mode defining a geofence condition; determining a status of the geofence condition; and implementing a responsive action based on the determined status of the geofence condition.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of a cooking appliance according to one or more exemplary embodiments of the present subject matter.

FIG. 2 provides a side cross-sectional view of the exemplary cooking appliance of FIG. 1 according to one or more exemplary embodiments of the present subject matter.

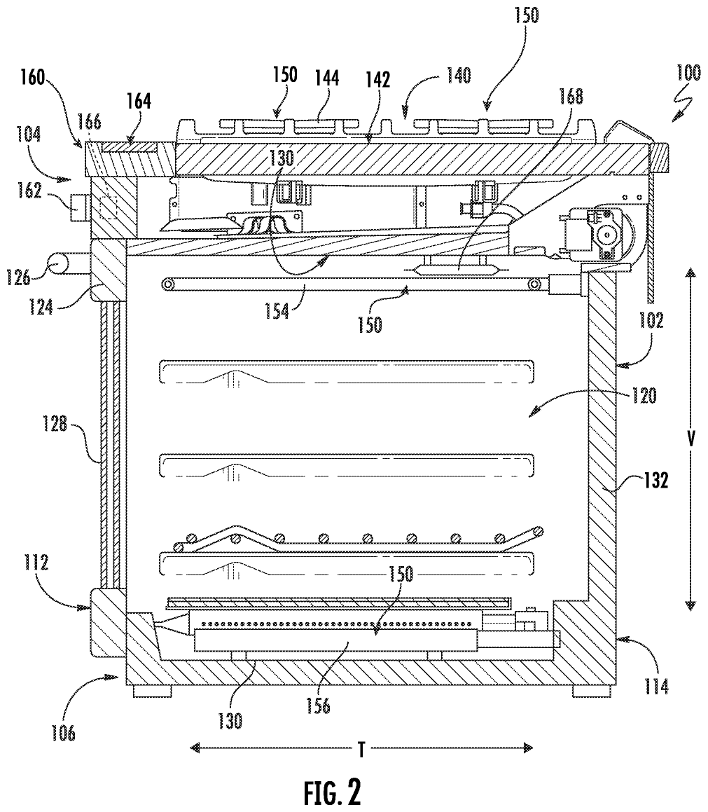

FIG. 3 provides a method of operating a cooking appliance according to one or more exemplary embodiments of the present subject matter.

FIG. 4 provides an exemplary sequence of user options on a user interface of the exemplary cooking appliance of FIG. 1 and on an external device associated with the exemplary cooking appliance according to one or more exemplary embodiments of the present subject matter.

FIG. 5 provides an exemplary sequence of user options on a user interface of the exemplary cooking appliance of FIG. 1 according to one or more exemplary embodiments of the present subject matter.

FIG. 6 provides an exemplary sequence of user options on a user interface of the exemplary cooking appliance of FIG. 1 according to one or more exemplary embodiments of the present subject matter.

FIG. 7 provides an exemplary sequence of user options on a user interface of the exemplary cooking appliance of FIG. 1 according to one or more exemplary embodiments of the present subject matter.

FIG. 8 provides an exemplary geofence according to one or more exemplary aspects of the present subject matter.

FIG. 9 provides an exemplary geofence according to one or more exemplary aspects of the present subject matter.

FIG. 10 provides an exemplary flow chart illustrating a method of operating a cooking appliance according to one or more exemplary embodiments of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a 10 percent margin.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

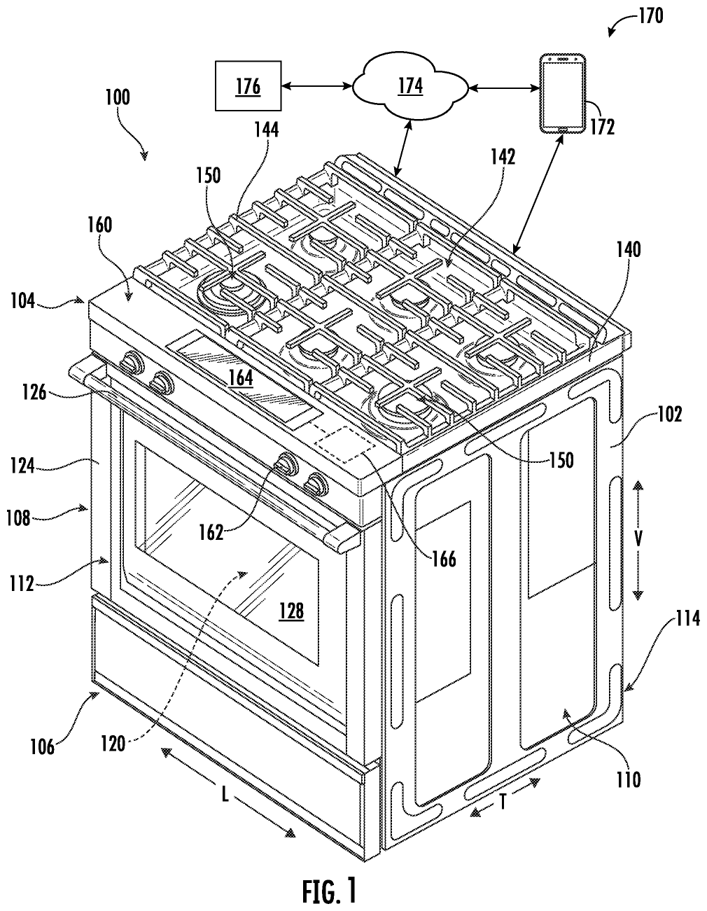

FIG. 1 provides a front, perspective view of a cooking appliance 100 as may be employed with the present subject matter. Cooking appliance 100 generally defines a vertical direction V, a lateral direction L, and a transverse direction T, each of which is mutually perpendicular, such that an orthogonal coordinate system is generally defined. As illustrated, cooking appliance 100 includes an insulated cabinet 102. Cabinet 102 of cooking appliance 100 extends between a top 104 and a bottom 106 along the vertical direction V, between a first side 108 (left side when viewed from front) and a second side 110 (right side when viewed from front) along the lateral direction L, and between a front 112 and a rear 114 along the transverse direction T.

Within cabinet 102 is a single cooking chamber 120 which is configured for the receipt of one or more food items to be cooked. However, it should be appreciated that cooking appliance 100 is provided by way of example only, and aspects of the present subject matter may be used in any suitable cooking appliance, such as a double oven range appliance or a standalone cooktop appliance. Thus, the example embodiment shown in FIG. 1 is not intended to limit the present subject matter to any particular cooking chamber configuration or arrangement.

Cooking appliance 100 includes a door 124 rotatably attached to cabinet 102 in order to permit selective access to cooking chamber 120. Handle 126 is mounted to door 124 to assist a user with opening and closing door 124 in order to access cooking chamber 120. As an example, a user can pull on handle 126 mounted to door 124 to open or close door 124 and access cooking chamber 120. One or more transparent viewing windows 128 (FIG. 1) may be defined within door 124 to provide for viewing the contents of cooking chamber 120 when door 124 is closed and also assist with insulating cooking chamber 120.

In general, cooking chamber 120 is defined by a plurality of chamber walls 130. Specifically, cooking chamber 120 may be defined by a top wall, a rear wall, a bottom wall, and two sidewalls 130. These chamber walls 130 may be joined together to define an opening through which a user may selectively access cooking chamber 120 by opening door 124. In order to insulate cooking chamber 120, cooking appliance 100 includes an insulating gap defined between the chamber walls 130 and cabinet 102. According to an exemplary embodiment, the insulation gap is filled with an insulating material 132, such as insulating foam or fiberglass, for insulating cooking chamber 120.

Cooking appliance 100 also includes a cooktop 140. Cooktop 140 is positioned at or adjacent top 104 of cabinet 102 such that it is positioned above cooking chamber 120. Specifically, cooktop 140 includes a top panel 142 positioned proximate top 104 of cabinet 102. By way of example, top panel 142 may be constructed of glass, ceramics, enameled steel, and combinations thereof. One or more grates 144 are supported on a top surface of top panel 142 for supporting cooking utensils, such as pots or pans, during a cooking process.

Cooking appliance 100 may further include one or more heating elements (identified generally by reference numeral 150) for selectively heating cooking utensils positioned on grates 144 or food items positioned within cooking chamber 120. For example, referring to FIG. 1, heating elements 150 may be gas burners 150. Specifically, a plurality of gas burners 150 are mounted within or on top of top panel 142 underneath grates 144 that supports cooking utensils over the gas burners 150 while gas burners 150 provide thermal energy to cooking utensils positioned thereon, e.g., to heat food or cooking liquids (e.g., oil, water, etc.). Gas burners 150 can be configured in various sizes for the receipt of cooking utensils (i.e., pots, pans, etc.) of various sizes and configurations and to provide different heat inputs for such cooking utensils. According to alternative embodiments, cooking appliance 100 may have other cooktop configurations or burner elements.

In addition, heating elements 150 may be positioned within or may otherwise be in thermal communication with cooking chamber 120 for regulating the temperature within cooking chamber 120. Specifically, an upper gas heating element 154 (also referred to as a broil heating element or gas burner) may be positioned in cabinet 102, e.g., at a top portion of cooking chamber 120, and a lower gas heating element 156 (also referred to as a bake heating element or gas burner) may be positioned at a bottom portion of cooking chamber 120. Upper gas heating element 154 and lower gas heating element 156 may be used independently or simultaneously to heat cooking chamber 120, perform a baking or broil operation, perform a cleaning cycle, etc. The size and heat output of gas heating elements 154, 156 can be selected based on, e.g., the size of cooking appliance 100 or the desired heat output. Cooking appliance 100 may include any other suitable number, type, and configuration of heating elements 150 within cabinet 102 or on cooktop 140. For example, cooking appliance 100 may further include electric heating elements, induction heating elements, or any other suitable heat generating device.

A control panel assembly 160 is located within convenient reach of a user of the cooking appliance 100. For this example embodiment, control panel assembly 160 is positioned at a top 104 and front 112 of cabinet 102, e.g., above door 124 along the vertical direction V and forward of cooktop 140 along the transverse direction T. Control panel assembly 160 includes knobs 162 that are each associated with one of heating elements 150. In this manner, knobs 162 allow the user to activate each heating element 150 and determine the amount of heat input provided by each heating element 150 for cooking food items within cooking chamber 120 or on cooktop 140. Although shown with knobs 162, it should be understood that knobs 162 and the configuration of cooking appliance 100 shown in FIG. 1 is provided by way of example only. More specifically, control panel assembly 160 may include various input components, such as one or more of a variety of touch-type controls, electrical, mechanical or electro-mechanical input devices including rotary dials, push buttons, and touch pads. Control panel assembly 160 may also be provided with one or more graphical display devices or display components, such as a digital or analog display device designed to provide operational feedback or other information to the user such as e.g., whether a particular heating element 150 is activated or the rate at which the heating element 150 is set. Indeed, according to the illustrated embodiment, control panel assembly 160 includes a display assembly 164, such as a liquid crystal display with an interactive display and interface.

Generally, cooking appliance 100 may include a controller 166 in operative communication with control panel assembly 160. Control panel assembly 160 of cooking appliance 100 may be in communication with controller 166 via, for example, one or more signal lines or shared communication busses, and signals generated in controller 166 operate cooking appliance 100 in response to user input via user input devices, e.g., control knobs 162 or display assembly 164. Input/Output (“I/O”) signals may be routed between controller 166 and various operational components of cooking appliance 100 such that operation of cooking appliance 100 can be regulated by controller 166. In addition, controller 166 may also be in communication with one or more sensors, such as temperature sensor 168, which may be used to measure temperature inside cooking chamber 120 and provide such measurements to the controller 166. Although temperature sensor 168 is illustrated at a top and rear of cooking chamber 120, it should be appreciated that other sensor types, positions, and configurations may be used according to alternative embodiments.

Controller 166 is a “processing device” or “controller” and may be embodied as described herein. Controller 166 may include a memory and one or more microprocessors, microcontrollers, application-specific integrated circuits (ASICS), CPUs or the like, such as general or special purpose microprocessors operable to execute programming instructions or micro-control code associated with operation of cooking appliance 100, and controller 166 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog or digital logic circuitry (such as switches, amplifiers, integrators, comparators, flip-flops, AND gates, and the like) to perform control functionality instead of relying upon software.

Referring still to FIG. 1, a schematic diagram of an external communication system 170 will be described according to an exemplary embodiment of the present subject matter. In general, external communication system 170 is configured for permitting interaction, data transfer, and other communications between cooking appliance 100 and one or more external devices. For example, this communication may be used to provide and receive operating parameters, user instructions or notifications, performance characteristics, user preferences, or any other suitable information for improved performance of cooking appliance 100. In addition, it should be appreciated that external communication system 170 may be used to transfer data or other information to improve performance of one or more external devices or appliances or improve user interaction with such devices.

For example, external communication system 170 permits controller 166 of cooking appliance 100 to communicate with a separate device external to cooking appliance 100, referred to generally herein as an external device 172. As described in more detail below, these communications may be facilitated using a wired or wireless connection, such as via a network 174. In general, external device 172 may be any suitable device separate from cooking appliance 100 that is configured to provide or receive communications, information, data, or commands from a user. In this regard, external device 172 may be, for example, a personal phone, a smartphone, a tablet, a laptop or personal computer, a wearable device, a smart home system, or another mobile or remote device. The external device 172 may also include or be provided as a global positioning system (GPS) receiver. Such a GPS receiver is generally configured for receiving transmissions from GPS satellites. As is understood, the GPS receiver can establish or determine a location of GPS receiver (and thus cooking appliance 100) using such transmissions.

In addition, a remote server 176 may be in communication with cooking appliance 100 or external device 172 through network 174. In this regard, for example, remote server 176 may be a cloud-based server 176, and is thus located at a distant location, such as in a separate state, country, etc. According to an exemplary embodiment, external device 172 may communicate with a remote server 176 over network 174, such as the Internet, to transmit/receive data or information, provide user inputs, receive user notifications or instructions, interact with or control cooking appliance 100, etc. In addition, external device 172 and remote server 176 may communicate with cooking appliance 100 to communicate similar information.

In general, communication between cooking appliance 100, external device 172, remote server 176, or other user devices or appliances may be carried using any type of wired or wireless connection and using any suitable type of communication network, non-limiting examples of which are provided below. For example, external device 172 may be in direct or indirect communication with cooking appliance 100 through any suitable wired or wireless communication connections or interfaces, such as network 174. For example, network 174 may include one or more of a local area network (LAN), a wide area network (WAN), a personal area network (PAN), the Internet, a cellular network, any other suitable short-or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), or protection schemes (e.g., VPN, secure HTTP, SSL).

External communication system 170 is described herein according to an exemplary embodiment of the present subject matter. However, it should be appreciated that the exemplary functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Although aspects of the present subject matter are described herein in the context of a single cooking appliance, it should be appreciated that cooking appliance 100 is provided by way of example only. Other cooking, oven, or range appliances having different configurations, different appearances, or different features may also be utilized with the present subject matter, e.g., double ovens, connected oven/cooktop units, etc. Moreover, aspects of the present subject matter are equally applicable to standalone cooktops (e.g., without cooking chambers) or other cooking appliances.

Now that the construction and configuration of cooking appliance 100 has been described according to exemplary embodiments of the present subject matter, exemplary methods (e.g., 200 or 500) for operating cooking appliance 100 will be described according to an exemplary embodiment of the present subject matter. The below-described methods can be used to operate cooking appliance 100 or may be used to operate any other suitable cooking appliances. In this regard, for example, controller 166 may be configured for implementing some or all steps of method 200 or 500. Further, it should be appreciated that the exemplary methods 200 and 500 discussed herein only describe exemplary aspects of the present subject matter, and is not intended to be limiting.

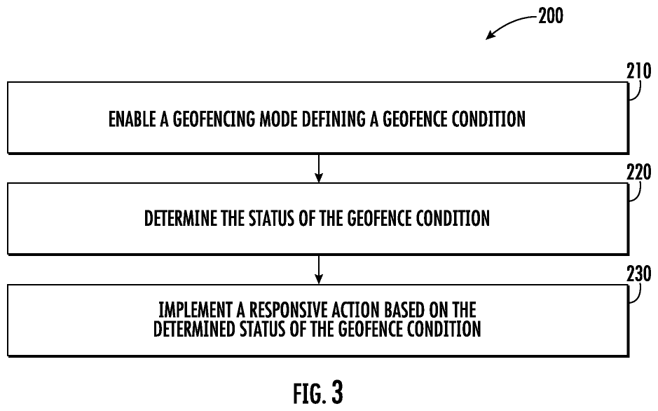

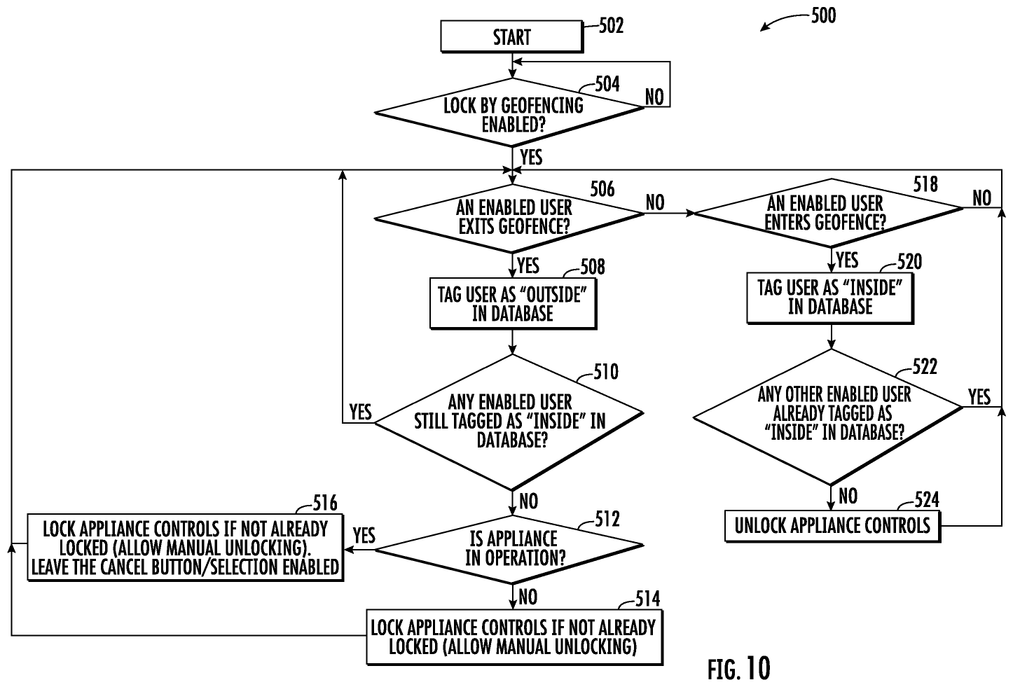

It is noted that FIGS. 3 and 10 depict steps performed in a particular order for purpose of illustration and discussion. Those of ordinary skill in the art, using the disclosures provided herein, will understand that (except as otherwise indicated) methods 200 and 500 are not mutually exclusive. Moreover, the steps of the methods 200 and 500 can be modified, adapted, rearranged, omitted, interchanged, or expanded in various ways without deviating from the scope of the present disclosure.

As will be appreciated, the exemplary methods (e.g., 200 or 500) may advantageously activate, or deactivate, one or more operational modes of a cooking appliance through the use of GPS geofencing. For instance, by utilizing geofencing the one or more operational modes of the cooking appliance may advantageously be activated or deactivated when a user moves outside or inside a geofence boundary, respectively.

Referring now to FIG. 3, method 200 includes at, step 210, enabling a geofencing mode defining a geofence condition. The geofencing mode may be considered to be “enabled” when a user has selected such a mode for a user account associated with the cooking appliance. As will be described in more detail below, a user may enable a geofencing mode for a user account associated with the cooking appliance on a user interface panel (e.g., such as the control panel 160).

Generally, the geofencing mode may be utilized to automate the activation of one or more operational modes of the cooking appliance. In this regard, the geofencing mode may be enabled or disabled for one or more operational modes of the cooking appliance. The one or more operational modes of the cooking appliance may include a control lock mode or a restricted mode of operation, for instance, an access control mode or a serenity mode. The geofencing mode may be enabled within the lock control mode or the restricted mode of operation and utilized to automatically (e.g., without direct or manual user interaction) activate the lock control mode or the restricted mode of operation. In this regard, activation, or deactivation, of the lock control mode or the restricted mode of operation may occur only when the mode is enabled and a triggering event (e.g., a change in status of the geofence condition) or a direct manual input by a user on the user interface panel has occurred.

When activated, the control lock mode may lock, or disable functionality, of the user interface panel. For example, the control lock mode may be utilized when a primary user, for example, an adult or parent, leaves a household the cooking appliance may be located in. This may ensure a secondary user, for example, a child, cannot utilize the cooking appliance. Additionally or alternatively, when a restricted mode of operation is activated, operational features of the cooking appliance may be limited or restricted. For example, when the access control mode is activated, only preselected or quick access cycle options of the cooking appliance may be selected. As another example, when the serenity mode is activated, various limits or restrictions of the cooktop appliance are enabled. For instance, a cooktop temperature restriction may be activated. The cooktop temperature restriction may include limiting or restricting a power level of one or more heating elements of the cooking appliance. As another example, a cooktop duration alert may be activated. The cooktop duration alert may be emitted when a timer has reached a predetermined limit, for instance, when the cooktop (e.g., one or more heating elements) has been energized for a predetermined amount of time. As yet another example, a cooktop timeout restriction may be activated. The cooktop timeout restriction may include turning off the cooktop (e.g., one or more heating elements) when a timer has reached a predetermined limit, for instance, when the predetermined amount of time of the cooktop duration limit has been reached. As another example, operation in a cooking chamber only mode may be enabled and activated. The operation in the cooking chamber mode may restrict or limit utilization of the cooking appliance to only the cooking chamber. These restricted modes of operations are intended to prevent unintentional misuse of cooking appliances, for example, by children or individuals with memory loss or cognitive impairments.

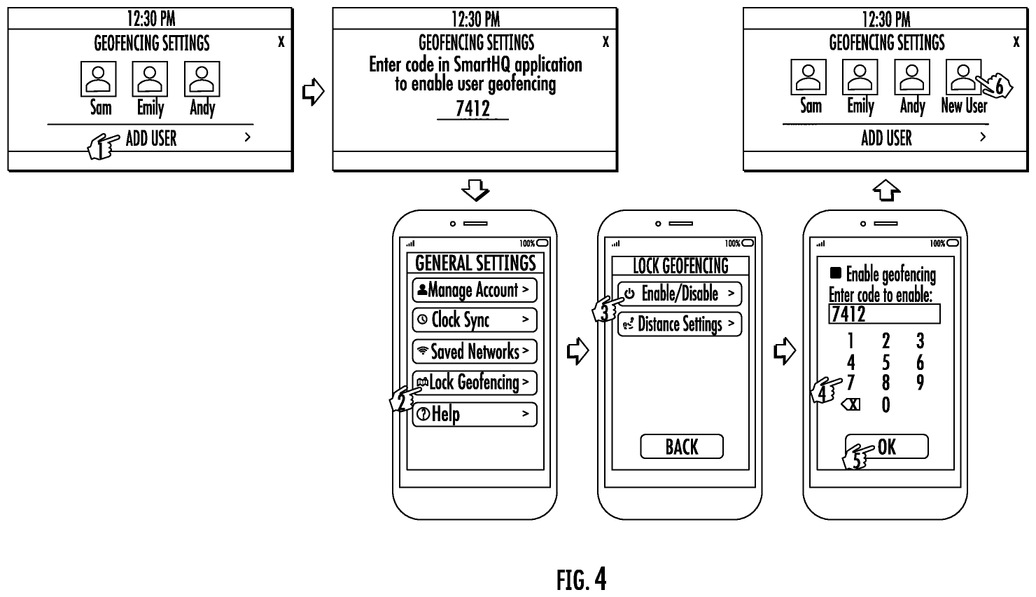

As should be appreciated, the geofencing mode may be enabled or disabled for one or more user accounts in a user list stored on a geofencing database. Thus, in some embodiments, the step 210 includes adding a user list to a geofencing database, for instance, on a user interface panel of the cooking appliance. The user list may include a list of all user accounts associated with the cooking appliance. User accounts may be added, or removed, from the user list. When a user account is added to the user list, the geofencing mode may be enabled or disabled. For example, as shown in FIG. 4, a user account may be added to the user list. Additionally, the geofencing mode may be enabled or disabled for the added user account. Specifically, a user may select add user on the user interface panel of the cooking appliance. A connection code or pin may be generated (e.g., via a preprogrammed connection code generator stored on the controller of the cooking appliance) that the appliance user may be directed to input on an external device (e.g., within an app on the external device) to connect the external device to the cooking appliance. Further, on the external device, the user may select the geofencing mode (e.g., the lock geofencing menu as shown in FIG. 4), select the enable/disable menu within the geofencing mode, and input the generated connection code or pin on the external device to enable the user account within the user list.

In some embodiments, the geofencing database is stored on a remote server (e.g., remote server 176). Additionally or alternatively, in some other embodiments, the geofencing database is stored directly on the cooking appliance (e.g., stored within memory of a controller such as memory of the controller 166).

The step 210 may also include determining a cooking appliance reference location. The cooking appliance reference location may generally correspond to the geographical location of the cooking appliance. For instance, the cooking appliance reference location may include the geographic coordinates (e.g., latitudinal or longitudinal coordinates) that define the geographical location of the cooking appliance. In some embodiments, the one or more external devices linked to the cooking appliance are utilized to obtain the cooking appliance reference location. For instance, the one or more external devices may be Global Positioning System (GPS) enabled external devices. The one or more external devices may be in close proximity to the cooking appliance. In this regard, when the one or more external devices receive a GPS signal corresponding to the physical position or address of the one or more external devices, that physical position or address may be associated with the cooking appliance. Optionally, a user may confirm the appropriate cooking appliance reference location (e.g., at the user interface panel of the cooking appliance or the one or more external devices, as is understood). In this regard, the cooking appliance reference location may be determined by obtaining GPS or geographical coordinates via the one or more external devices. The cooking appliance reference location may be transmitted to the geofence database and used as a reference location for a boundary or perimeter described in more detail below.

Further, in some such embodiments, the step 210 includes receiving a boundary input. The boundary input may define the geofence condition for the user list. Generally, the boundary input may define a geographical boundary or perimeter (e.g., “geofence settings”) for the geofence condition. The geographical boundary or perimeter may surround the cooking appliance reference location. In some embodiments, the boundary input includes one or more boundary inputs. The one or more boundary inputs may each include selected geographic reference points or locations relative to the cooking appliance reference location. The selected geographic reference points or locations may be user selected geographic reference points or locations. For example, a user may input a predetermined distance that corresponds to the selected geographic reference points or locations. As another example, a user may “draw” or create a free form set of selected geographic reference points or locations on a map of the geographical locations surrounding the cooking appliance reference location.

Each boundary input of the one or more boundary inputs may be associated with a discrete user account stored within the user list. In this regard, each user account may be associated with a unique geographical boundary or perimeter. For example, a first user may be associated with a first geofence boundary and a second user may be associated with a second geofence boundary. In some exemplary embodiments, the first geofence boundary and the second geofence boundary may be different or separate geofence boundaries.

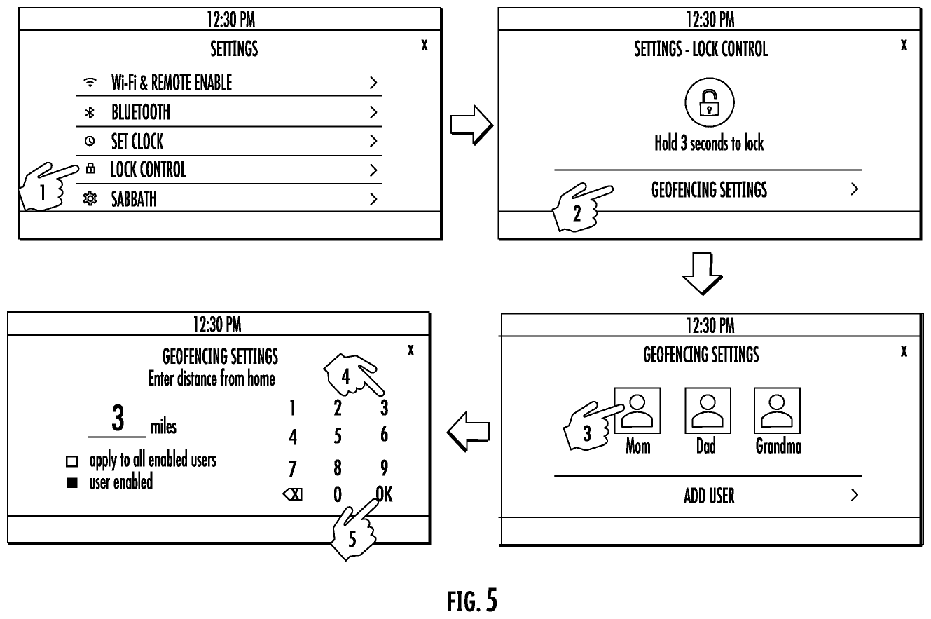

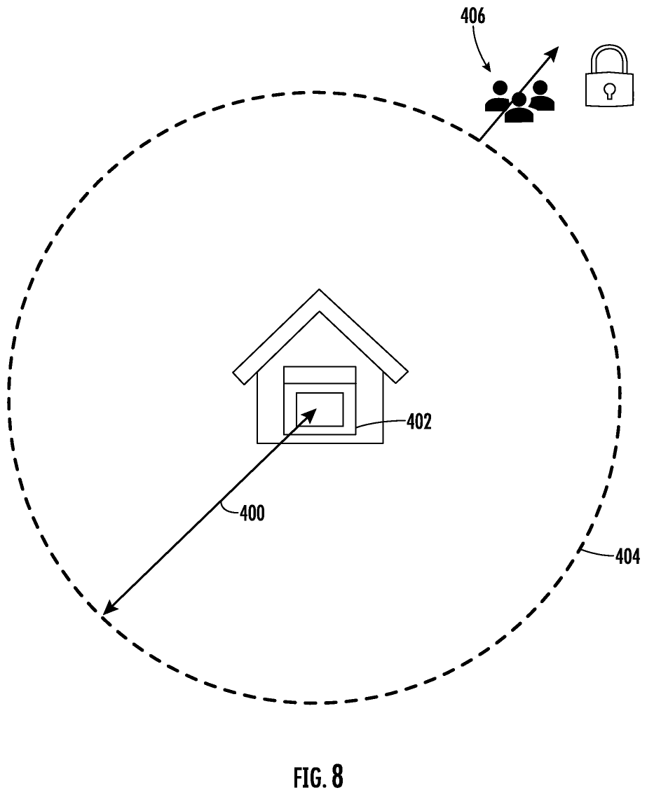

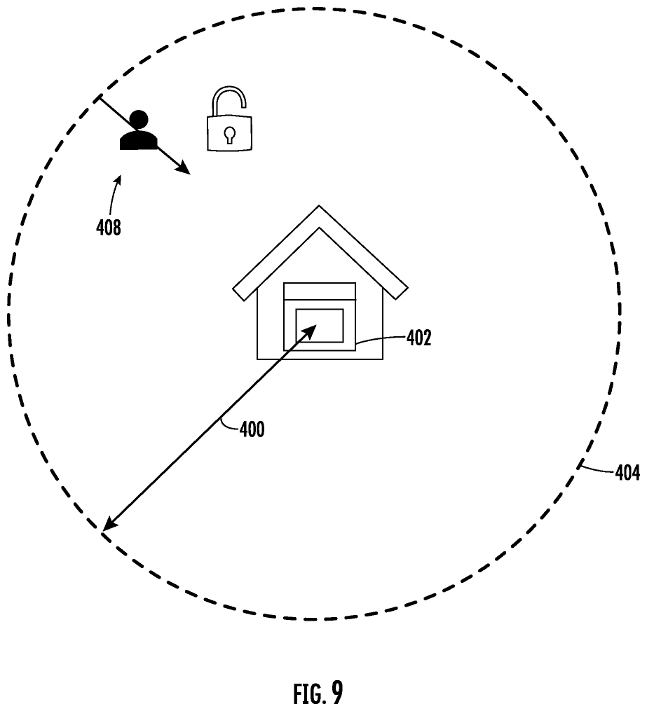

As shown in FIG. 5, a user may input a boundary input via the user interface panel for a discrete user account. Specifically, a user may select a desired operational mode within a settings page (e.g., the lock control menu as shown in FIG. 5), select geofencing settings, select an enabled user account, enter a desired distance from the cooking appliance reference location (e.g., a radius, in miles, such as a distance 400 from cooking appliance reference location 402 shown in FIGS. 8 and 9), and select “OK” to input the desired distance from the cooking appliance reference location.

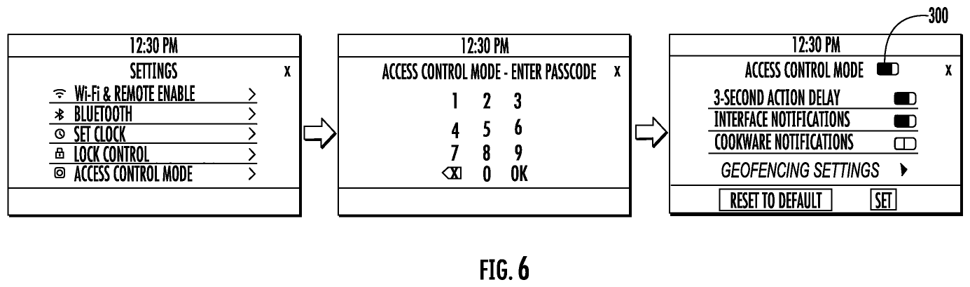

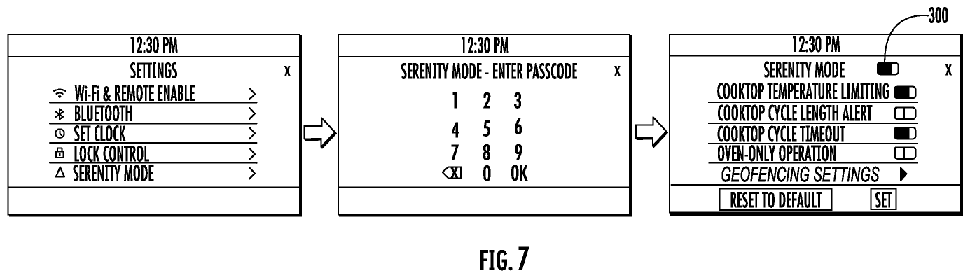

Additionally or alternatively, the geofence settings may be enabled within the restricted modes of operation. For example, as illustrated in FIGS. 6 and 7, when the virtual switch 300 is pressed to enable the access control mode (e.g., FIG. 6) or the serenity mode (e.g., FIG. 7), boundary inputs for the restricted modes of operation may also be received. For example, a user may select the geofencing settings menu. Once the geofencing settings menu has been selected, a user may be directed to input a boundary input via the user interface panel, such as shown in FIG. 5. As illustrated in FIGS. 6 and 7, a user may be required to enter a predefined passcode before being allowed to change settings for the restricted modes of operation.

In some embodiments, the boundary input includes a geofence boundary defining a constant radius boundary. In such embodiments, the geofence boundary forms a circular boundary around the cooking appliance reference location (see, e.g., geofence boundary 404 of FIGS. 8 and 9). In some embodiments, the constant radius of the geofence boundary is measured in miles. In other words, when the geofence boundary defines a constant radius boundary, the geofence boundary may be a constant or consistent mileage away from the cooking appliance reference location in any direction.

In some other embodiments, the boundary input includes a geofence boundary defining a free form boundary. In such embodiments, the geofence boundary forms a boundary that may not conform to a regular or formal structure. For instance, such geofence boundaries may include inconsistent or irregular distances (e.g., in miles) away from the cooking appliance reference location in any direction. The free form boundary may be a user made boundary that defines the geofence boundary. Specifically, a user may draw the free form boundary relative to the cooking appliance reference location, for example, on a GPS enabled external device.

Referring again to FIG. 3, step 220 may generally include determining a status of the geofence condition. Generally, the status of the geofence condition may correspond to the location of all users in a user list relative to the corresponding geofence boundary. For instance, the status of a geofence condition may be fulfilled when at least one user of a user list is inside the corresponding geofence boundary. A user may be “inside” its corresponding geofence boundary when a geographic location of the user account, and more particularly, the geographic location of the external device associated with the user account is within the geofence boundary. Conversely, the status of the geofence condition may be broken when at least one user in a user list is outside its corresponding geofence boundary. A user may be “outside” its corresponding geofence boundary when the geographic location of the user is not within the geofence boundary.

In some embodiments, the step 220 includes detecting that all users in a user list are outside a geofence boundary. That is, at step 220, it may be detected that all users have exited the geofence boundary. For example, as illustrated in FIG. 8, all users 406 in the user list may be outside or may have exited the geofence boundary 404. In some such embodiments, the step 220 further includes determining the geofence condition is broken in response to detecting that all users in a user list are outside the geofence boundary.

In some other embodiments, the step 220 includes detecting that at least one user in the user list is inside the geofence boundary. That is, at step 220, it may be detected that at least one user has entered or is within the confines of the geofence boundary. For example, as illustrated in FIG. 9, at least one user 408 is inside the geofence boundary 404. In such embodiments, the step 220 further includes determining the geofence condition is fulfilled in response to detecting that at least one user in a user list is inside the geofence boundary.

Based on the determined status of the geofence condition, step 230 may include implementing a responsive action. In some embodiments, the step 230 includes activating the control lock mode. For instance, when the geofencing settings for the control lock mode are enabled for one or more users within the user list and when the geofence condition is broken (e.g., in response to detecting that all users in the user list are outside the geofence boundary, such as at step 220), step 230 may include activating the control lock mode. When activated, the control lock mode may lock, or disable functionality, of the user interface panel. In this regard, when all users in the user list are outside the geofence boundary the control lock mode may advantageously be activated without direct or manual user interaction.

Additionally or alternatively, in some embodiments, the step 230 includes deactivating the control lock mode. For instance, in response to the geofence conditions being fulfilled (e.g., in response to detecting that at least one user in the user list entered the geofence boundary), step 230 may include deactivating the control lock mode. When deactivated, the user interface panel may become unlocked. In this regard, a user may be capable of utilizing the user interface panel.

In some other embodiments, the step 230 includes activating a restricted mode of operation. For instance, when the geofence settings for the restricted modes of operation (e.g., the access control mode or the serenity mode) are enabled and when the geofence condition is broken (e.g., in response to detecting that all users in the user list are outside the geofence boundary, such as at step 220), step 230 may include activating the restricted mode of operation (e.g., activating the access control mode or the serenity mode). Furthermore, activating the restricted mode of operation may limit various operational features of the cooking appliance such as cooktop power, cycle duration, cooking chamber preheating, etc.

Additionally or alternatively, in some other embodiments, the step 230 includes deactivating the restricted mode of operation and returning to a normal (e.g., unrestricted) mode of operation. For instance, in response to the geofence conditions being fulfilled (e.g., in response to detecting that at least one user in the user list entered the geofence boundary), step 230 may include deactivating the restricted mode. Furthermore, deactivating the restricted mode of operation may return the cooking appliance to a normal operation mode. For instance, various operational features of the cooking appliance may function as normal when the restricted mode of operation is deactivated.

Referring now to FIG. 10, an exemplary control method 500 for implementing a control lock mode will be described according to an exemplary embodiment. As shown, the method 500 begins at step 502. For instance, the method 500 may begin in response to a user enabling one or more geofencing operational modes (e.g., the control lock mode described in more detail above) of the cooking appliance. Step 504 includes determining whether control lock mode with geofencing is enabled. In this regard, for example, the control lock mode with geofencing is considered to be “enabled” when a user has selected such a mode using a user interface (e.g., such as control panel assembly 160) and has added and enabled at least one user account with its corresponding geofencing settings. If the control mode with geofencing is enabled, step 506 may include determining if an enabled user (e.g., a user that has been previously added to a user list) has exited the geofence. For example, an enabled user is considered to have exited the geofence (e.g., be outside the geofence) if the geographic location of a user account (e.g., the geographic location of an external device associated with the user account) is outside a geofence boundary associated with the user account.

If step 506 results in a determination that the user has exited the geofence, step 508 may include tagging a user as “outside” in a database (e.g., a geofence database described in more detail above). When the user is tagged as “outside” in the database, step 510 may include determining if any enabled user is still tagged as “inside” in a database. For example, if any user account associated with the cooking appliance has fulfilled the geofence condition the user account may still be tagged as “inside.” As another example, user accounts may initially be tagged as “inside.” For instance, when the user account is initially added to a user list, it may be tagged as “inside” in the geofence database. In this regard, a user account may be tagged as “inside” until the user account has been tagged as “outside.” If step 510 results in a determination that there are enabled users still tagged as “inside” in the database, the method 500 may include continuing to monitor if an enabled user has exited the geofence. For instance, step 506, as described in more detail above, may be executed in response to determining that there are enabled users still tagged as “inside” in the database. If step 510 results in a determination that there are no enabled users still tagged as “inside” in the database, step 512 may include determining if the cooking appliance is in operation (e.g., to be actively used by a user). If step 512 results in a determination that the cooking appliance is not in operation, step 514 may include locking appliance controls if the cooking appliance is not already locked. For example, locking appliance controls may include locking the user interface from any undesired selections. That is the touch capability, or any other suitable capabilities of the user interface that a user may interact with, may be restricted, or limited. Additionally, after locking the appliance controls at step 514, manual unlocking of the cooking appliance may be allowed. For example, manual unlocking of the cooking appliance may include pressing and holding a virtual unlock button located on the user interface panel. The virtual unlock button may be held for a predetermined amount of time (e.g., three seconds) to manually unlock the cooking appliance. Further, if step 512 results in a determination that the cooking appliance is in operation, step 516 may include locking cooking appliance controls if they are not already locked. Additionally, manual unlocking of the cooking appliance controls may be allowed and the “Cancel” button or selection may be enabled to allow users to cancel or terminate appliance operation (e.g., a running cooking cycle) at any time. After locking the appliance controls at either step 514 or 516, method 500 may include continuing to monitor if a user has exited the geofence (e.g., step 506).

If step 506 results in a determination that the user has not exited the geofence, step 518 may include determining if an enabled user has entered the geofence. For example, an enabled user is considered to have entered the geofence if the geographic location of a user account (e.g., the geographic location of an external device associated with the user account) is inside a geofence boundary associated with the user account. If step 518 results in a determination that the user has not entered the geofence, method 500 may include continuing to monitor if a user has exited the geofence (e.g., step 506). If step 518 results in a determination that the user has entered the geofence, step 520 may include tagging a user as “inside” in a database (e.g., a geofence database described in more detail above). When the user is tagged as “inside” in the database, step 522 may include determining if there is any other enabled user already tagged as “inside” in the database. If step 522 results in a determination that there are not any other users already tagged as “inside” in the database, step 524 may include unlocking appliance controls and continuing to monitor if a user has exited the geofence. If step 522 results in a determination that there is another enabled user already tagged as “inside” in the database, method 500 may include continuing to monitor if a user has exited the geofence.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a cooking appliance, the method comprising:
enabling a geofencing mode defining a geofence condition;
determining a status of the geofence condition; and
implementing a responsive action based on the determined status of the geofence condition.

2. The method of claim 1, wherein determining the status of the geofence condition comprises:
detecting that all users in a user list are outside a geofence boundary; and
determining the geofence condition is broken in response to detecting that all users in a user list are outside the geofence boundary.

3. The method of claim 2, wherein implementing the responsive action comprises activating a control lock mode.

4. The method of claim 2, wherein implementing the responsive action comprises activating a restricted mode of operation.

5. The method of claim 2, wherein the user list comprises one or more user accounts, and wherein the geofence condition comprises one or more geofences, wherein each user account is associated with a corresponding geofence of the one or more geofences.

6. The method of claim 1, wherein determining the status of the geofence condition comprises:
detecting that at least one user in a user list is inside a geofence boundary; and
determining the geofence condition is fulfilled in response to detecting that at least one user in a user list is inside the geofence boundary.

7. The method of claim 6, wherein implementing the responsive action comprises deactivating a control lock mode.

8. The method of claim 6, wherein implementing the responsive action comprises deactivating a restricted mode of operation and returning to a normal mode of operation.

9. The method of claim 1, wherein enabling the geofencing mode comprises:
adding a user list to a geofencing database stored on a remote server, the user list being associated with one or more external devices;
determining, with the one or more external devices, a cooking appliance reference location; and
receiving a boundary input defining the geofence condition for the user list based on the determined cooking appliance reference location.

10. The method of claim 9, wherein the boundary input includes a geofence boundary defining a constant radius boundary.

11. The method of claim 9, wherein the boundary input includes a geofence boundary defining a free form boundary.

12. A cooking appliance defining a vertical direction, a lateral direction, and a transverse direction, the cooking appliance comprising:
a cooktop comprising one or more heating elements;
a user interface panel mounted to the cooktop for facilitating user interaction with the cooking appliance; and
a controller in operative communication with the user interface panel, the controller being configured for:
enabling a geofencing mode defining a geofence condition;
determining a status of the geofence condition; and
implementing a responsive action based on the determined status of the geofence condition.

13. The cooking appliance of claim 12, wherein determining the status of the geofence condition comprises:
detecting that all users in a user list are outside a geofence boundary; and
determining the geofence condition is broken in response to detecting that all users in a user list are outside the geofence boundary.

14. The cooking appliance of claim 13, wherein implementing the responsive action comprises activating a control lock mode.

15. The cooking appliance of claim 13, wherein the user list comprises one or more user accounts, and wherein the geofence condition comprises one or more geofences, wherein each user account is associated with a corresponding geofence of the one or more geofences.

16. The cooking appliance of claim 12, wherein determining the status of the geofence condition comprises:
detecting that at least one user in a user list is inside a geofence boundary; and
determining the geofence condition is fulfilled in response to detecting that at least one user in a user list is inside the geofence boundary.

17. The cooking appliance of claim 16, wherein implementing the responsive action comprises deactivating a control lock mode.

18. The cooking appliance of claim 12, wherein enabling the geofencing mode comprises:
adding a user list to a geofencing database stored on a remote server, the user list being associated with one or more external devices;
determining, with the one or more external devices, a cooking appliance reference location; and
receiving a boundary input defining the geofence condition for the user list based on the determined cooking appliance reference location.

19. The cooking appliance of claim 18. wherein the boundary input includes a geofence boundary defining a constant radius boundary.

20. The cooking appliance of claim 18. wherein the boundary input includes a geofence boundary defining a free form boundary.
